(19) United States
(12) Patent Application Publication
(10) Pub. No.: US 2014/0104321 A1
(43) Pub. Date: Apr. 17, 2014

(54) SYSTEM OF ADJUSTING ELECTRONIC DISPLAYS AND LIGHTING TO A CIRCADIAN RHYTHM

(71) Applicant: Gary Steffy, Ann Arbor, MI (US)

(72) Inventor: Gary Steffy, Ann Arbor, MI (US)

(21) Appl. No.: 13/849,335

(22) Filed: Mar. 22, 2013

Related U.S. Application Data
(60) Provisional application No. 61/712,343, filed on Oct. 11, 2012.

(51) Int. Cl. G09G 5/10

(52) U.S. Cl. CPC G09G 5/10
USPC 345/690

(57) ABSTRACT

A software determines the settings and timing of luminance and color emitting from an electronic device display based on an individual's circadian rhythm preferences. The circadian rhythm preferences of the individual may be determined by certain inputs by the individual. For example, the inputs may include a visual system age preference, an operation mode preference, and a degree of entrainment preference.

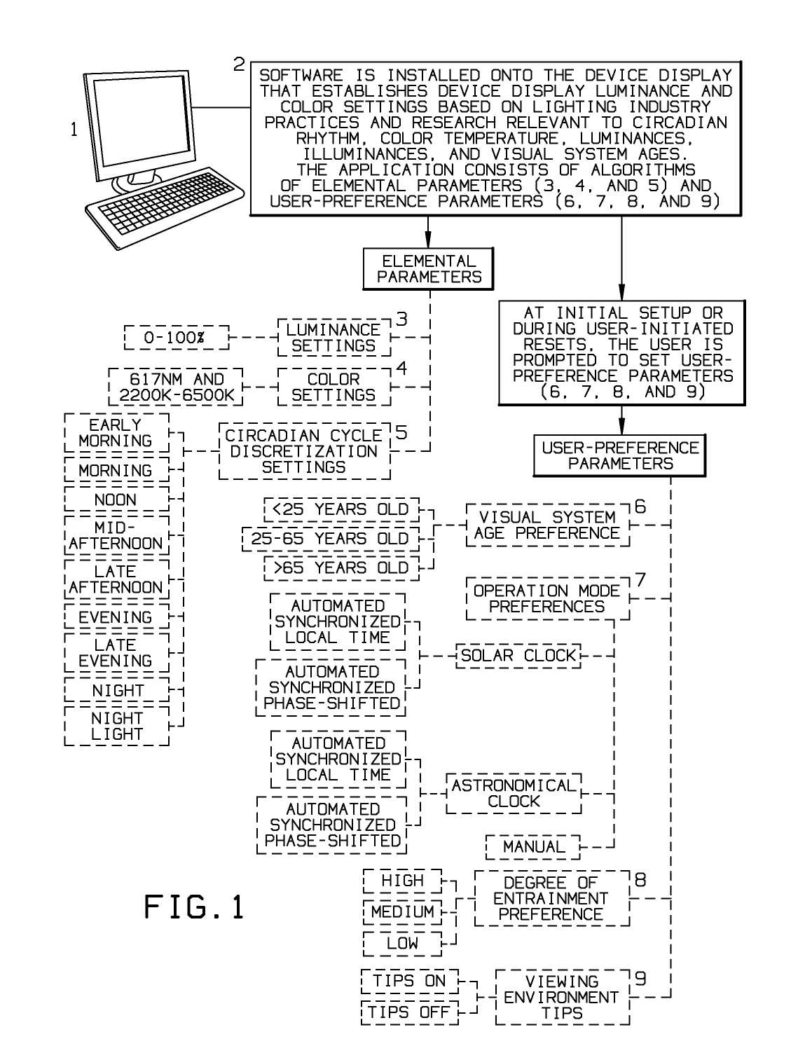

### BACKGROUND OF THE INVENTION

The present invention relates to a software that adjusts an electronic display and lighting system to the circadian rhythm and, more particularly, relates to a software that adjusts an electronic display and lighting system to the circadian rhythm based on an individual's inputted data.

The circadian rhythm is affected by a dynamically synchronized cycle of light and dark and color of light. Device displays may constitute a significant portion of many users' visual systems exposure to light. Device displays typically exhibit default high-level luminance (the display's inherent maximum luminance) and very cool-white color settings (typically of a color temperature of 6500K) appropriate to much of the wake phase, but not conducive to the pre-sleep or sleep phases. User-adjustments for luminance and, if available, color on device displays may be well-hidden, difficult to set (requiring at least two adjustments—one to luminance and one to color), are limited in breadth of choice, and, once set, are static until reset manually.

As can be seen, there is a need for software for controlling a device display or lighting to respond to a circadian rhythm.

### SUMMARY OF THE INVENTION

Some prior methods require use of unique device displays (hardware) to control display color or are dependent on unique systems of sensors. Additionally, some prior methods offer a one-size-fits-all approach regardless of user's visual system age and desired degree of entrainment. Thereby, the devices present the user with a default static color setting for daytime use, a static setting for nighttime use, and a single static luminance setting at all times. The result is device display settings of very limited applicability to any user's entire 24-hour circadian rhythm cycle, visual age, and degree of entrainment preferences.

In one aspect of the present invention, a system for displaying a circadian cycle from a display comprises: a computer having a user interface; and a program product comprising machine-readable program code for causing, when executed, the computer to perform the following process steps: prompting a user to select an operation mode comprising a synchronized local time comprising the local time, or a synchronized phase-shifted time comprising a selection of different global time zones; determining the luminance settings, the color settings and the circadian cycle discretization settings based on the inputted operation mode; and emitting luminance and color of the circadian rhythm based on the luminance settings, the color settings and the circadian cycle discretization settings.

In another aspect of the present invention, a system for displaying a circadian cycle from a display, comprising: a computer having a user interface; and a program product comprising machine-readable program code for causing, when executed, the computer to perform the following process steps: prompting a user to select an operation mode comprising a synchronized local time comprising the local time, or a synchronized phase-shifted time comprising a selection of different global time zones; prompting the user to select a degree of entrainment; prompting the user to select a visual system age preference; determining the luminance settings, the color settings and the circadian cycle discretization settings based on the inputted operation mode, the inputted degree of entrainment, and the inputted age preference; and emitting luminance and color of the circadian rhythm based on the luminance settings, the color settings and the circadian cycle discretization settings.

These and other features, aspects and advantages of the present invention will become better understood with reference to the following drawing, description and claims.

### BRIEF DESCRIPTION OF THE DRAWING

The FIGURE is a representative flowchart of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Broadly, an embodiment of the present invention provides a software that determines the settings and timing of luminance and color emitting from an electronic device display based on an individual's circadian rhythm preferences. The circadian rhythm preferences of the individual may be determined by certain inputs by the individual. For example, the inputs may include a visual system age preference, an operation mode preference, and a degree of entrainment preference.

The present invention may include at least one computer connected to a display. The computer may include any computer including, but not limited to, a desktop, laptop, and smart device, such as, a tablet and smart phone. The computer may be connected to or be part of any device display or luminous display or object, including but not limited to, monitors, medical devices, televisions, electronic eyewear, lighting system lamps, luminaires, and vehicle displays. The computer may include a program product including a machine-readable program code for causing, when executed, the computer to perform steps. The program product may include software that may be loaded onto the computer's hard drive or internal memory.

The present invention may be relevant to any electronic device display. In certain embodiments of the present invention, the software may be used on any red-green-blue-based (RGB) device display. The software may dynamically synchronize device display luminance and color settings over the entire circadian rhythm cycle for display viewing compatible with any time of day or night for various visual system age ranges. Luminance and colors may be synchronized over a 24-hour period to coordinate with user-selected age range, operation mode consisting of wake/sleep phase preference, and preferences for method of timing of the cycle phases, and degree of entrainment preference.

Luminance and color affect circadian rhythm. The wake phase may be characterized by very bright, very cool-white light, the pre-sleep phase may be characterized by dim, very warm-white light, and the sleep phase may be characterized by total dark, or where visual activity is absolutely necessary, very dim amber/orange light. By dynamically adjusting screen luminance and color in accordance with users' respective preferences for time of day synchronization, visual age, and degree of entrainment, the circadian rhythm display software of the present invention empowers users to synchronize device display viewing with their circadian rhythm preferences.

The addition of subroutines to monitor screen graphics and their color tendencies during the use of application programs and which make screen color temperature adjustments to favor the program's graphics' color tendencies may be of utility to users involved in late-day device display viewing involving color-sensitive viewing assignments where screen color temperatures of, say, 3500K are preferable to even lower values while still marginally contributing to circadian rhythm compared to device display defaults.

Referring to the Figure, the software 2 may be installed onto the computer connected to a display or luminous object 1. In certain embodiments, at initial setup, or during user-initiated presets, a user may be prompted to select user-preference parameters of visual system age preference 6, operation mode preferences 7, degree of entrainment preference 8, and viewing environment tips 9. The software 2 may then adjust the elemental parameters of device display 1 luminance settings 3 and color settings 4 according to circadian cycle discretization settings 5 for the user-selected parameters of visual age 6, operation mode preferences 7, and degree of entrainment preference 8. Tips 9, if user-selected, may be displayed periodically during transitions between circadian cycle discretization settings 5.

In certain embodiments, on automated-synchronized mode in the operation mode preferences 7, the device display may dynamically synchronize to the user's circadian rhythm preference on a 24-hour cycle. On manual mode in the operation mode preferences 7 the device display may be adjusted to a static user-selected luminance/color combination in accordance with user's visual age and degree of entrainment preferences.

As mentioned above, the software may include user-preference parameters and elemental parameters. The user-preference parameters may include the degree of entrainment preference 8, operation mode preference 7, visual system age preference 6, and viewing environment tips preference 9. For the degree of entrainment preference 8, the user may select the preferred degree or strength of the desired effect. For example, the user may select high, medium or low. For example, low entrainment selection may result in mild adjustments to luminance and color from mid-afternoon to night tailored to age which may encourage early cessation of device display viewing which may encourage more consistent sleep times and/or deeper sleep. Medium entrainment selection may result in moderate adjustments to luminance and color from mid-afternoon to night tailored to age which may encourage more consistent earlier cessation of device display viewing which may encourage consistent earlier sleep times and/or deeper sleep. High entrainment selection may result in the strong adjustments to luminance and color from mid-afternoon to night tailored to age which may encourage more consistent earliest sleep times and/or deeper sleep.

In certain embodiments, once entrainment 8 is selected, then the user may choose operation mode 7. The operation mode 7 may include automated mode and manual mode. If the user selects automated mode, the software may employ if/then logic to automatically and continually synchronize the device display to the user's preferred circadian rhythm. If the user selects manual mode, the software may employ if/then logic to adjust the device display setting to the user's preference of circadian cycle discretization. Thereby, the circadian cycle discretization setting becomes a user-preference parameter in the manual mode. The user may choose from such categories as early morning, morning, noon, mid-afternoon, late afternoon, evening, late evening, night, night light and the like.

In certain embodiments, if the automated mode is selected, the user may select the solar clock or the astronomical clock and a method of tracking time for each clock selected. The solar clock may include solar clock sequencing based on ever-changing sunrise and sunset timing—or solar tracking where the sun's position determines the schedule of circadian effects, a method which may be considered desirable by users seeking a seasonally-varied regimen of effects for medium or low entrainment. The astronomical clock may include astronomical time clock sequencing based on consistent hour-by-hour timing—or time-of-day tracking where actual clock time determines the schedule of circadian effects regardless of solar position, a method which may be considered desirable by users seeking a consistent regimen of effects for high, medium, or low entrainment. Within the solar clock and the astronomical clock settings, the user may select to synchronize in local time or synchronize to phase-shifted time. If the user selects synchronize to local time, the computer's internal clock may be used to sequence the circadian effects. If the user selects synchronize to phase-shifted time, the user may select from a global time zone drop-down menu which then delays or advances the computer's internal clock to sequence the circadian effects in accordance with the time shift.

The user may further select an age in the visual system age preference setting 6 to accommodate the effect of age on the sensitivity to luminance and color and their effects on the circadian rhythm. For example, the user may select under 25 years of age, 25 to 65 years of age, or over 65 years of age. However, the present invention is not limited to those age selections and may include any age selection desired. The user may further select whether to view tips in the viewing environment tips section 9. The user may select whether viewing environment tips should be displayed or not. For example, the user may select either “tips on” or “tips off”. The tips may include suggestions on locations which may exhibit lighting appropriate to the user's circadian preferences or may indicate a time which may be considered appropriate to cease device display viewing.

The elemental parameters may include subroutines that may coordinate various device display parameters with the various user preferences. The elemental parameters may include, but are not limited to, circadian cycle discretization setting 5, luminance settings 3, and color settings 4. The circadian cycle discretization settings 5 may be displayed based on the operation mode preferences 7 and may include such categories as early morning, morning, noon, mid-afternoon, late afternoon, evening, late evening, night, and night light.

The luminance setting 3 may be displayed from between 0% and about 100%. However, in certain embodiments, the luminance may incrementally brighten up to about 150% or more of normal (screen luminance overdrive) as well as incrementally dim to about 1%. These additions may amplify the effect of higher luminance during short-term daytime situations and lower luminance during nighttime situations. The color settings 4 may be displayed at, but not limited to about 617 nm and from, but not limited to, about 1800K to about 12,000K. For example, the temperature range may be from about 2200K to about 6500K. Luminance settings 3 may be absolute values (cd/m̂2) or percentage values relative to device display default maximum. Color settings 4 may be established with spectral power distributions (SPDs), correlated color temperatures (CCTs in Kelvin), wavelengths (nm), or RGB values.

The following is an example of the software selections and display. If a user selects the <25 year old visual system age, the astronomical clock automated synchronized local time mode, and high entrainment, and if it is mid-afternoon synchronization, then the device display may automatically: transition the screen luminance to 85% from the noon setting of 100% in a timed gradual fade; simultaneously transition screen color to 5000K from the noon setting of 6500K in a timed gradual fade; and briefly display a user tip. For example, the tip may advise the user to seek bright places such as study halls, classrooms, libraries, offices and the like. For the same user, if it is an evening synchronization, then the device display may automatically: transition screen luminance to 60% from a late afternoon setting of 75% in a timed gradual fade; and simultaneously transition the screen color to 2200K from a late afternoon setting of 3000K in a timed gradual fade; and briefly display a user tip. For example, the tip may advise the user to seek dim places such as dimmed home or home-like lounge and living areas.

A method of using the software may include the following. On initial installation of the software on the computer device display or on reset of the software, the user may identify preferred visual system age from a range of choices, indicate preferred operation mode from a range of choices, indicate preferred degree of entrainment, and indicate preference for viewing application tips or no tips. When the software is engaged in one of the automated modes, device display luminance and color may automatically and dynamically synchronize with discrete circadian rhythm cycle phases in accordance with user-selected age and entrainment preferences in a seamless and continual 24-hour loop adjusted to user-selected preferences for phase-shifting and method of timing of the cycle phases. When in an automated mode, essentially, to better conform device displays to a circadian rhythm, screen luminance and color may automatically and dynamically synchronize throughout the day, with brightest luminance and relatively cool colors emitted from the device display during various discrete phases of morning and early afternoon; with dimmer luminance and relatively warm colors emitted from the device display during various discrete phases of late afternoon and evening; and with dimmest luminance and very warm colors emitted from the device display during various discrete phases of late evening and night.

New situational categories may be established, along with respective luminance, color, and circadian cycle discretization settings to enable the device display screen or lighting system settings to respond to any number of conditions or situations where luminance, color, and circadian cycle discretization settings may be synchronized automatically and dynamically or manually in accordance with user preferences or prescriptive needs. Medical devices may include luminance and color-range requirements that may be significantly expanded beyond those typical to consumer products. Prescription versions of the software application may then be available to assist medical practitioners in addressing such light-treatment-responsive medical conditions such as Seasonal Affective Disorder

(SAD), sleep disorders, and Alzheimer's through synchronized luminance and color on discrete circadian rhythm cycle phases. Medical patient rooms may be designed with lighting systems controlled by the present invention to provide more robust wake/sleep cycles during hospitalization. Similarly, spa, meditation, and fitness settings may be illuminated with lighting systems controlled by the software of the present invention.

The circadian cycle discretizations and sequencing may be rearranged to address specific, partial-day activities, such as night driving. Vehicle device displays and interior lighting systems may be developed to optimize the advantage that the circadian rhythm settings have on driver alertness. For example, vehicle display's luminance, colors and/or interior vehicle lighting may be synchronized to vehicle-integrated sleep-monitoring devices, for example, and change display screen luminance and color to about 100% and about 6500K and subsequently modulate luminance and color to enhance user's alert state, essentially phase-shifting the driver's circadian rhythm. Similar situations occur with night-shift work, where device displays or lighting systems may be set to phase-shifted day-time luminance and colors and/or modulated to enhance user's alert state.

In certain embodiments, luminance settings, color settings, and the circadian cycle settings may be more minutely discretized. In certain embodiments, automated program effects may be triggered by device-integrated photocells rather than time clocks. Additional preference settings may be based on in situ environmental lighting conditions read by photocells and colorimeters integrated into device displays or standalone auxiliary plug-in devices.

It should be understood, of course, that the foregoing relates to exemplary embodiments of the invention and that modifications may be made without departing from the spirit and scope of the invention as set forth in the following claims.

What is claimed is:

1. A system for displaying a circadian cycle from a display, comprising:
a computer having a user interface and connected to at least one of a device display and lighting; and
a program product comprising machine-readable program code for causing, when executed, the computer to perform the following process steps:
prompting a user to select an operation mode comprising a synchronized local time comprising the local time, or a synchronized phase-shifted time comprising a selection of different global time zones;
determining the luminance settings, the color settings and the circadian cycle discretization settings based on the inputted operation mode; and
emitting luminance and color of the circadian rhythm using the luminance settings, the color settings and the circadian cycle discretization settings.

2. The system of claim 1, wherein the luminance settings are from 0 to about 150%.

3. The system of claim 1, wherein the color settings are at about 617 nm and a color temperature from about 2200K to about 6500K.

4. The system of claim 1, wherein the circadian cycle discretization settings is selected from the group consisting of early morning, morning, noon, mid-afternoon, late afternoon, evening, late evening, night, night light, and the like.

5. The system of claim 1, wherein the operation mode further comprises a manual selection, wherein the user selects the circadian cycle discretization setting manually.

6. The system of claim 1, wherein the program product further causes the machine to prompt the user to select a degree of entrainment wherein the inputted operation mode and degree of entrainment is used to determine the luminance settings, the color settings and the circadian cycle discretization settings

7. The system of claim 6, wherein the degree of entrainment is selected from the group consisting of a low setting, a medium setting and a high setting.

8. The system of claim 1, wherein the program product further causes the machine to prompt the user to select a visual system age preference, wherein the inputted operation mode and visual system age preference is used to determine the luminance settings, the color settings and the circadian cycle discretization settings.

9. The system of claim 8, wherein the visual system age preference is selected from the group consisting of less than 25 years old, 25 years old and up to 65 years old, and greater than 65 years old.

10. The system of claim 1, wherein the program product further causes the machine to prompt the user to select a viewing environment tips on selection or a viewing environment tips off selection, wherein the viewing environment tips on selection provides circadian cycle tips to a user.

11. A system for displaying a circadian cycle from a display, comprising:
a computer having a user interface and connected to at least one of a device display and lighting; and
a program product comprising machine-readable program code for causing, when executed, the computer to perform the following process steps:
prompting a user to select an operation mode comprising a synchronized local time comprising the local time, or a synchronized phase-shifted time comprising a selection of different global time zones;
prompting the user to select a degree of entrainment;
prompting the user to select a visual system age preference;
determining a luminance settings, a color settings and a circadian cycle discretization settings based on the inputted operation mode, the inputted degree of entrainment, and the inputted age preference; and
emitting luminance and color of the circadian rhythm based on the luminance settings, the color settings and the circadian cycle discretization settings.

12. The system of claim 11, wherein the luminance settings are from 0 to about 150%.

13. The system of claim 11, wherein the color settings are 617 nm and color temperature is from about 2200K to about 6500K.

14. The system of claim 11, wherein the circadian cycle discretization settings is selected from the group consisting of early morning, morning, noon, mid-afternoon, late afternoon, evening, late evening, night, and late night light.

15. The system of claim 11, wherein the operation mode further comprises a manual selection, wherein the user selects the preferred circadian cycle discretization setting manually.

16. The system of claim 11, wherein the degree of entrainment is selected from the group consisting of a low setting, a medium setting and a high setting.

17. The system of claim 11, wherein the visual system age preference is selected from the group consisting of less than 25 years old, 25 years old and up to 65 years old, and greater than 65 years old.

18. The system of claim 1, wherein the program product further causes the machine to prompt the user to select a viewing environment tips on selection or a viewing environment tips off selection, wherein the viewing environment tips on selection provides circadian cycle tips to a user.
